(19) United States
(12) Patent Application Publication
(10) Pub. No.: US 2013/0262302 A1
(43) Pub. Date: Oct. 3, 2013

(54) SYSTEMS, METHODS, AND COMPUTER PROGRAM PRODUCTS FOR PROVISIONING PAYMENT ACCOUNTS INTO MOBILE WALLETS AND MANAGING EVENTS

(71) Applicant: JVL VENTURES, LLC, New York, NY (US)

(72) Inventors: Greg A. Lettow, Leawood, KS (US); Kiran H. Srinivasamurthy, Bangalore (IN)

(73) Assignee: JVL Ventures, LLC, New York, NY (US)

(21) Appl. No.: 13/848,962

(22) Filed: Mar. 22, 2013

Related U.S. Application Data
(60) Provisional application No. 61/619,332, filed on Apr. 2, 2012.

(51) Int. Cl. G06Q 20/36

(52) U.S. Cl. CPC G06Q 20/367
USPC 705/41

(57) ABSTRACT

Systems, methods, and computer program products are provided for provisioning service accounts into mobile wallets and managing events. A first request is received from a requestor system, and stored in memory. A second request based on the first request is transmitted to a server. A response, including a response code indicating a status of processing of the first request, is transmitted to the requestor system. The first request is one of a request to: set up a service account, update a service account state, update information in a mobile wallet, manage messages, obtain account information, or publish event information.

### CROSS REFERENCE TO RELATED APPLICATION

This application claims priority to U.S. Provisional Application No. 61/619,332, filed Apr. 2, 2012, the contents of which are incorporated herein by reference.

### BACKGROUND OF THE INVENTION

1. Field of the Invention

The present invention generally relates to mobile wallets in mobile devices for use in mobile commerce, and more particularly to systems, methods, and computer program products for provisioning service accounts into mobile wallets, and managing events within a mobile commerce system.

2. Related Art

A service provider (SP) is a company, organization, entity, or the like, that provides services to customers or consumers. Examples of service providers include account-issuing entities such as banks, merchants, card associations, marketing companies, and transit authorities. A service may be an activity, capability, functionality, work, or use that is permitted or provided by a service provider, such as a payment service, credit, debit, checking, gift, offer or loyalty service, transit pass service, and the like.

In a mobile commerce environment, service providers (i.e., service provider systems) had to communicate with multiple other varying systems in order to fully process requests. Typically, to process a request on a mobile device, a service provider had to communicate with the mobile device and/or other related systems. Service providers had to be adaptable to a large number of mobile devices, equipped with different hardware and being serviced by different mobile network operators (MNOs). That is, there has not been an interface for communicating between service providers and other systems such as mobile devices.

Additionally, requests to be processed on mobile devices have required a mobile device to retrieve data from an associated secure element or the like. In this regard, there is a need for an interface that includes, and can transmit, data to other systems for processing requests, thereby eliminating the need for those systems to fetch such information.

Service providers typically issue accounts to users and link each account to a service. Examples of service accounts may be a credit, checking, debit account, and the like. Each service account is associated with a service and a service provider. In a mobile environment that involves contactless transactions between a mobile device and a service provider, the mobile device must be equipped with service accounts in order to enable transactions to be performed.

Equipping mobile devices with service accounts requires service account information, applications, and any data necessary to utilize the service account to be successfully integrated into the mobile device and/or its secure element.

A mobile device, such as a cell phone or tablet, may be equipped with a secure element. A secure element is a platform onto which service account information and corresponding applications may be added. It consists of hardware, software, interfaces, and protocols that enable the secure storage of service account information and applications, which may be used for the execution of transactions.

A secure element may be implemented in different form factors such as a Universal Integrated Circuit Card (UICC), an embedded secure element, or NFC enablers such as a separate chip or secure device, which can be inserted into a slot on the mobile device. Typically a UICC is in the form of a subscriber identity module (SIM), which is controlled by the MNOs. An embedded secure element gives service providers the option to embed the secure element into the phone itself. One way in which secure element form factors are implemented is defined in, for example, GlobalPlatform Card Specification Versions 2.1.1 and 2.2 (hereinafter “Global Platform”).

A secure element may include one or more security domains (SDs), each of which may be used to separately and securely store data, such as service account information and applications, for different service providers.

Typical service providers manage the process of equipping mobile devices and secure elements with service accounts by performing a large number of steps to set up each account on each mobile device, including, for example: collecting and transmitting service account information to each mobile wallet and mobile wallet issuer; ensuring that each mobile device and corresponding mobile network operator (MNO) is eligible to be equipped with a service account; installing required services and applications to be used with each service account; and adding sensitive payment credentials to each secure element on each mobile device.

In addition, service providers must also be able to receive and transmit messages, updates, notifications, and status changes, from and to each mobile wallet equipped with a service account.

As a result, service providers are faced with the overwhelming task of continuously communicating with a variety of entities such as MNOs, mobile wallets, and the systems of mobile wallet issuers. During these communications, service providers must be able to manage (i.e., collect, transmit, update) a vast amount of information for each service account.

One technical challenge in setting up service accounts in mobile devices on mobile wallets in mobile devices, and subsequently managing communications and events to and from service providers, is due to the processing limitations of service providers. Namely, service providers do not have the capability of centrally, securely and efficiently processing requests for a large number of systems, including requests to set up service accounts and manage communications and events with a large number of different mobile devices.

### BRIEF DESCRIPTION

The present invention provides systems, methods, and computer program products for provisioning service accounts into mobile wallets and managing events.

In one embodiment, a system for managing communications includes at least one memory coupled to a processor. A first request is received from a requestor system, and the first request is stored in the at least one memory. A second request based on the first request is transmitted to a mobile wallet server. A response, including a response code indicating a status of processing of the first request, is transmitted to the requestor system. The first request is one of a request to: set up a service account, update a service account state, update information in a mobile wallet, manage messages, obtain account information, or publish event information.

In another embodiment, a method of managing communications includes: receiving a first request from a requestor system; storing the first request in at least one memory; transmitting, to a mobile wallet server, a second request based on the first request; and transmitting a response to the requestor system, the response including a response code indicating a status of processing of the first request. The first request is one of a request to: set up a service account, update a service account state, update information in a mobile wallet, manage messages, obtain account information, or publish event information. In another embodiment, a non-transitory computer-readable stores sequences of instructions for causing one or more processors to: receive a first request from a requestor system; store the first request in at least one memory; transmit, to a mobile wallet server, a second request based on the first request; and transmit a response to the requestor system, the response including a response code indicating a status of processing of the first request. The first request is one of a request to: set up a service account, update a service account state, update information in a mobile wallet, manage messages, obtain account information, or publish event information.

### BRIEF DESCRIPTION OF THE DRAWINGS

The features and advantages of the present invention will become more apparent from the detailed description set forth below when taken in conjunction with the following drawings.

FIG. 1 is a diagram of a system for provisioning service accounts into mobile wallets and managing events according to an exemplary embodiment.

FIG. 2 is a sequence diagram illustrating a sequence for setting up a service account on a mobile wallet according to an exemplary embodiment.

FIG. 3 is a sequence diagram illustrating a sequence updating the state of a service account on a mobile wallet according to an exemplary embodiment.

FIG. 4 is a sequence diagram illustrating a sequence for updating soft card information on a mobile wallet according to an exemplary embodiment.

FIG. 5 is a sequence diagram illustrating a sequence for managing messages to a mobile wallet according to an exemplary embodiment.

FIG. 6 is a sequence diagram illustrating a sequence for obtaining a balance summary of service accounts in mobile wallets according to an exemplary embodiment.

FIG. 7 is a sequence diagram illustrating a sequence diagram for managing events related to mobile wallets according to an exemplary embodiment.

FIG. 8 is a block diagram of an exemplary system useful for implementing the present invention.

### DETAILED DESCRIPTION

### I. Overview

The example embodiments of the invention presented herein are directed to systems, methods, and computer program products for provisioning service accounts into mobile wallets and managing events, which are now described herein in terms of an example system in a mobile commerce environment. This is for convenience only and is not intended to limit the application of the present invention. In fact, after reading the following description, it will be apparent to one skilled in the relevant art(s) how to implement the following invention in alternative environments such as mobile marketing, advertising, ticketing, information services, browsing, and the like.

Generally, a system, such as a central enterprise service bus (ESB), is provided for managing interactions between service provider systems and mobile devices, and grants the service provider systems the ability to efficiently and securely communicate with the mobile devices in order to, for example, set up a service account or transmit a message, without the need for directly communicating with each mobile device. Particularly, the ESB is a system for managing communications between mutually interacting systems and/or entities. In an exemplary embodiment, the ESB is operable to perform duties such as: managing and controlling requests and messages, handle and choreograph events, queue and organize events, etc. Interacting systems and/or entities may be publishers that transmit data to the ESB. In turn, the ESB publishes the data to subscriber systems, such as systems corresponding to (or controlled and/or managed by) entities such as MNOs, trusted service managers (TSMs), mobile wallets, mobile wallets issuers, and/or service providers.

A service provider system (i.e., service provider) transmits a request to an ESB to set up a service account in a mobile wallet. The request may be self-prompted by the service provider or may be sent in response to a prompt from the mobile wallet. It may also include service account information, which is to be used to set up the service account on the mobile wallet. Service account information includes, for example, a service account reference number, service provider identifier (ID), service product type, wallet instance ID, target mobile device number (MDN), etc. Service account information is discussed in further detail below with reference to Table 1.

The ESB receives the request from the service provider and transmits, based on the service account information in the request, a request to a server to create a service account record on the server. The server, in turn, creates a service account record based on the received service account information, and transmits a response to the ESB. The response includes information indicating whether or not the service account record was successfully created on the server, as requested by the ESB.

Upon receiving the response, the ESB publishes the information in the response (i.e., whether or not the service account record was successfully created on the server) to the service provider.

In turn, the ESB performs a business eligibility check (i.e., MNO eligibility check) and a technical eligibility check (i.e., TSM eligibility check). In particular, the ESB transmits a request to an MNO corresponding to the mobile device equipped with the mobile wallet, to perform the business eligibility check. The MNO determines whether the MDN identified in the service account information is valid, and then transmits a response to the ESB indicating whether or not the MDN is valid (i.e., whether or not the business eligibility check passed). If the business eligibility check passed, the ESB publishes information indicating this to the service provider.

A central TSM is a system for interfacing service providers and secure elements, for example to pre-personalize a secure element, transmit scripts to be processed and the like. U.S. patent application Ser. No. 13/653,160, entitled “Systems, Methods, and Computer Program Products for Interfacing Multiple Service Provider Trusted Service Managers and Secure Elements,” which is incorporated herein by reference in its entirety, provides an exemplary embodiment of a central TSM for managing communications between service providers and secure elements.

The ESB then transmits a request to a central TSM associated with the mobile wallet to perform the technical eligibility check. The central TSM determines whether the secure element associated with the mobile wallet may be equipped with a service account and its corresponding application. In turn, the central TSM transmits a response to the ESB indicating whether or not the technical eligibility passed. If the technical eligibility check passed, the ESB publishes information indicating this to the service provider.

In turn, the ESB transmits to the central TSM a request to install and/or instantiate one or more applications corresponding to the service of the service account on the secure element. The central TSM processes the request and provides a response to the ESB indicating whether or not the installation and/or instantiation of the one or more applications was successful.

Further, the ESB transmits, to the server, a request to add “soft card” information to the mobile wallet. The soft card information is based on information received by the ESB in the initial request to set up the service account, and includes, for example, service account reference number, and/or service provider ID. The server receives the request and then synchronizes the mobile wallet so that it includes the received soft card information.

After the mobile wallet has been synchronized, the server transmits a response to the ESB indicating whether or not the soft card information was successfully added to the mobile wallet. In turn, the ESB transmits a response to the service provider indicating whether or not the service account was set up as originally requested.

The service provider then transmits a request to the central TSM to install credentials, such as an account number and expiration date, on the secure element. The central TSM then installs the credentials on the secure element, and transmits a response to the ESB indicating that the credentials were installed.

In turn, the ESB sets the service account state to “waiting for activation” until the service provider receives instructions to activate the service account, for example, from a user of the mobile wallet with the service account. The ESB then updates the state of the service account to “active,” thereby making the service account usable to conduct transactions.

### II. System

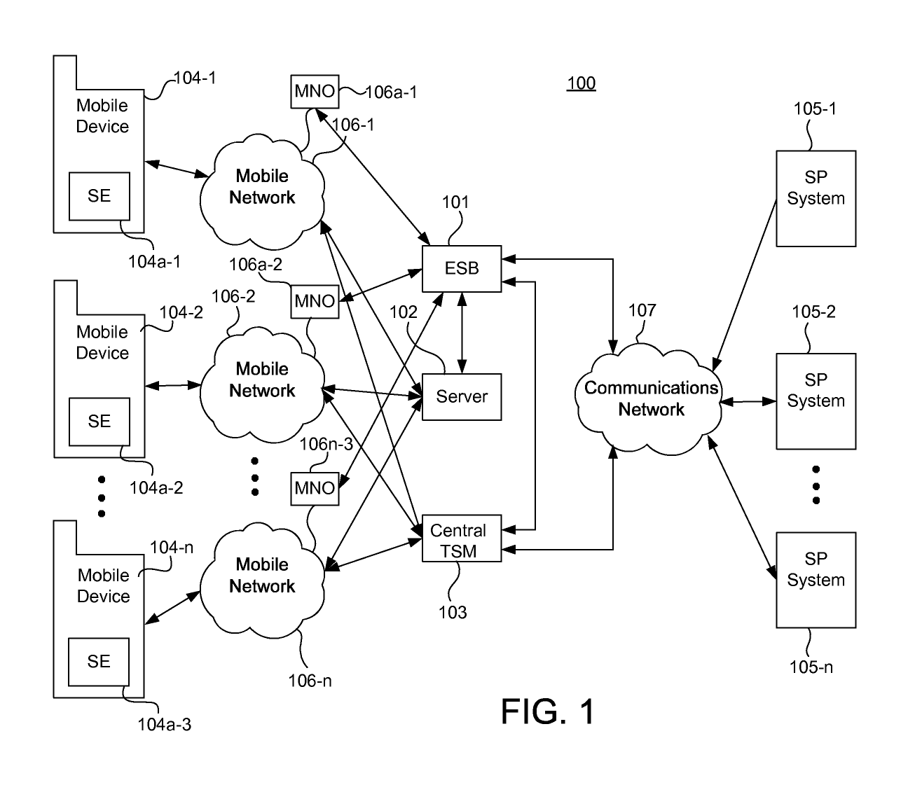

FIG. 1 is a diagram of an exemplary system 100 for provisioning service accounts into mobile wallets and managing events. As shown in FIG. 1, system 100 includes an ESB 101, which is communicatively coupled to a server 102 (which may also be referred to as a “wallet server” or “mobile wallet server) and a central TSM 103. In addition, the ESB 101 is communicatively coupled to SP systems 105-1, 105-2, . . . , 105-n (collectively “105”) via a communications network 107. Communications network 107 may be a virtual private network (VPN), a network using Hypertext Transfer Protocol (HTTP) standards, or the like.

Additionally, the server 102 and the central TSM 103 are each communicatively coupled to mobile devices 104-1, 104-2, . . . , 104-n (collectively “104”) via corresponding mobile networks 106-1, 106-2, . . . , 106-n (collectively “106”). Each of the mobile networks 106 is operated by a corresponding MNO 106a-1, 106a-2, . . . , 106a-n (collectively “106a”).

The server 102 and the central TSM 103 communicates with mobile devices 104 via the mobile networks 106, using security protocols such as Global Platform secure channel protocol, SSL, TLS, or the like. Mobile networks 106 may be mobile phone cellular networks, radio networks, or the like.

Each of the mobile devices 104 includes a corresponding secure element 104a-1, 104a-2, . . . , 104a-n (collectively “104a”), and a corresponding a mobile wallet 104b-1, 104b-2, . . . , 104b-n (collectively “104b”). Each of the mobile devices 104 may include a user interface such as a display.

A mobile wallet (e.g., mobile wallet 104b-1, 104b-2, . . . , 104b-n) is an application stored in a non-transitory memory of a mobile device including instructions which, when executed by the processor of a mobile device, cause the mobile device to act as an instrument, for example, for processing contactless transactions or for processing commerce information such as offer or loyalty information. A mobile wallet and a corresponding secure element may communicate using ISO 7816 commands, in order to conduct contactless transactions.

In an example embodiment, the ESB 101 is hardware and/or software that is implemented to serve as an intermediary between SP systems 105 and mobile devices 104, for example, for provisioning service accounts in mobile wallets and managing events.

In another example embodiment, the processes and functions described below with reference to an ESB (e.g., ESB 101) can be performed by a central TSM (e.g., central TSM 103).

### III. Process

### A. Setting Up a Service Account on a Mobile Wallet

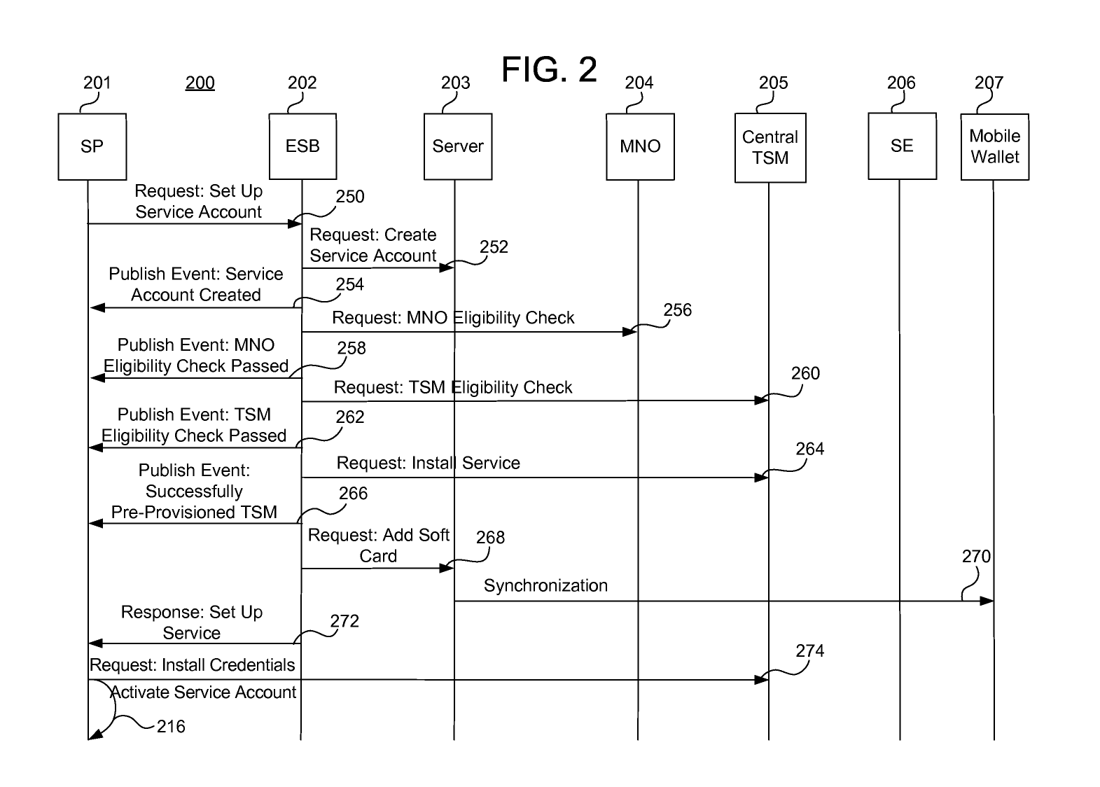

FIG. 2 depicts a sequence diagram 200 for setting up a service account on a mobile wallet according to an exemplary embodiment.

As shown in FIG. 2, at step 250, an ESB 202 (e.g., FIG. 1, ESB 101) receives a request to set up a service account (Request: Set Up Service Account) from a service provider 201 (e.g., FIG. 1, service provider 105-1). This request follows the “asynchronous message with callback” pattern, and may include a message header. Table 5, below, illustrates example parameters defining a message header in a request (e.g., Request: Set Up Service Account).

Additionally, Table 1 illustrates example parameters defining a request to set up a service account (e.g., Request: Set Up Service Account) according to sequence 200.

The following tables indicate required parameters according to the exemplary embodiments described below. It should be understood that variations of whether each parameter is or is not required are possible, and such variations are not limited by the example embodiments described below.

TABLE 1
Examples of Set Up Service Account Request Parameters

| No. | Parameter | Description | Required |
|---|---|---|---|
| 220 | Call Initiator | Entity or system initiating request | Yes |
| 221 | Service Account | Account based service product | Yes |
| | | offered to consumers by | |
| | | service providers | |

Call Initiator 220 includes information that may be used to determine the entity that initiated the request. A call initiator may be, for example, a service provider or a mobile wallet.

Service Account 221 includes information that may be used to determine the account-based service product offered by a service provider to a consumer. A service account may be, for example, credit, debit (i.e., linked checking), pre-paid, and/or eCash (e.g., restricted or general purpose reloadable (GPR)) account. Table 2 illustrates example parameters defining a service account (e.g., Service Account 221) according to sequence 200.

TABLE 2
Examples of Service Account Parameters

| No. | Parameter | Description | Required |
|---|---|---|---|
| 222 | Service | Unique number provided by a service | Yes |
| | Account | provider to uniquely identify a | |
| | Ref. No. | service account | |
| 223 | Service | Unique identifier used to identify a | Yes |
| | Provider ID | service provider | |
| 224 | Service | Type of service product | Yes |
| | Product | | |
| | Type | | |
| 225 | Operational | Mode in which a service account is | No |
| | Mode | operating | |
| 226 | Product | Product brand such as an | Yes |
| | Brand | enumerated value | |
| | Profile ID | | |
| 227 | Payment | Payment network associated with a | Yes |
| | Network | service provider | |
| 228 | Expiration | Date on which a service account | No |
| | Date | expires and is no longer usable | |
| 229 | Service | Indicator of the current state of a | Yes |
| | Account | service account | |
| | State | | |
| 230 | Provisioned | Indicator of whether a service | No |
| | Flag Type | account is provisioned on a | |
| | | mobile device | |
| 231 | Security | Unique identifier used to identify a | No |
| | Domain ID | particular security domain, in a | |
| | | secure element, on which a service | |
| | | account resides | |
| 232 | Wallet | Unique identifier used to identify a | No |
| | Instance ID | mobile wallet, or an instance of a | |
| | | mobile wallet, that is associated | |
| | | with a service account | |
| 233 | Target MDN | Phone number associated with a | Yes |
| | | mobile device on which a service | |
| | | account will be set up | |
| 234 | Service | Unique identifier used to identify a | No |
| | Application | service application, or an instance | |
| | Instance ID | of a service application, that | |
| | | is associated with a service account | |
| 235 | AuthAppAID | Unique identifier supplied by a | No |
| | | service provider to a mobile | |
| | | wallet issuer | |
| 236 | Last Four | Last four digits of an account number | No |
| | Digits of | corresponding to a service account | |
| | Account No. | | |
| 237 | Account | Nickname of a service account | No |
| | Nickname | | |
| 238 | MNO ID | Unique identifier used to identify a | No |
| | | mobile network operator associated | |
| | | with a consumer | |
| 239 | GP Service | Unique identifier of a service | No |
| | | provided by Global Platform | |

Service Account Ref No. 222 is a unique number provided by a service provider to identify a service account. This unique number may also be referred to as a “Payment Account Reference Number” (PRN).

Service Product Type 224 is type of service product, and may be, for example, credit, linked checking, debit, pre-paid, eCash, and/or the like.

Operational Mode 225 is a mode in which a service account is operating, and may be, for example, restricted and/or GPR.

Payment Network 227 is the payment network associated with a service account, and may be, for example, MASTER CARD, VISA, AMERICAN EXPRESS, DISCOVER, and/or the like.

Service Account State 229 is the current state of a service account, which may be, for example: registered, waiting for activation, active, closed, closed to new purchases, and/or suspended.

Wallet Instance ID 232 is a unique identifier for identifying a mobile wallet, and may be created based on an MDN provided by a service provider when a service account is initially established.

Target MDN 233 is a phone number associated with a mobile device on which a service account will be set up. In particular, a user may provide an MDN to a service provider when applying to obtain a service account. In turn, a service provider may provide the MDN to a mobile wallet issuer along with a service account reference number, so that a mobile wallet, or an instance of a mobile wallet, can correctly be associated with a service account.

Service Application Instance ID 234 is a unique identifier for identifying a service application, or an instance of a service application, associated with a service account. A service application instance ID is created when a service account is set up (or provisioned) on a mobile device and stored on a security domain associated with the service account.

MNO ID 238 is a unique identifier for identifying a mobile network operator associated with a consumer, and may be, for example, AT&T, T-MOBILE, VERIZON, and/or the like.

GP Service 239 includes information that may be used to determine a GlobalPlatform service or services to be installed in association with a mobile wallet on a mobile device. Table 3 illustrates example parameters defining a Global Platform service (e.g., GP Service 239) according to sequence 200.

TABLE 3
Examples of GP Service Parameters

| No. | Parameter | Description | Required |
|---|---|---|---|
| 240 | GP Service ID | Combination of service identifier and | Yes |
| | | service qualifier information | |
| 241 | AID | Application name and AID of | No |
| | Applications | applications to be instantiated in | |
| | | association with a mobile wallet | |
| | | on a mobile device | |

GP Service ID 240 includes information that may be used to determine the service or services to be installed in association with a mobile wallet on a mobile device. A GP Service ID (e.g. GP Service ID 240) may be defined by a Service ID and/or Service Qualifier. A Service ID may be used to identify an NFC service to be installed in association with a mobile wallet on a mobile device. A Service ID may include a Service Version, which is information indicating the version of a service. A Service Qualifier may include information to further qualify and/or define a service. For example, if a multiple instances of a service are installed in association with a mobile wallet on a mobile device, the Service Qualifier may be used to refer to a particular instance of the service.

As further shown on FIG. 2, at step 252, the ESB 202 transmits a request (Request: Create Service Account) to the server 203 (e.g., FIG. 1, server 102). In particular, this request is a request to create a service account record on the server 203. A service account record includes information associated with a service account, which may be defined by one or more of the parameters identified in Table 1. Additionally, the request to create a service account (Request: Create Service Account) may be based on information in the request to set up a service account (Request: Set Up Service Account) received by the ESB 202.

The server 203 processes the request (Request: Create Service Account) and creates a service account record on the server 203. In response, the server 203 may transmit a response to the ESB 202, indicating whether the service account record was successfully created, as requested.

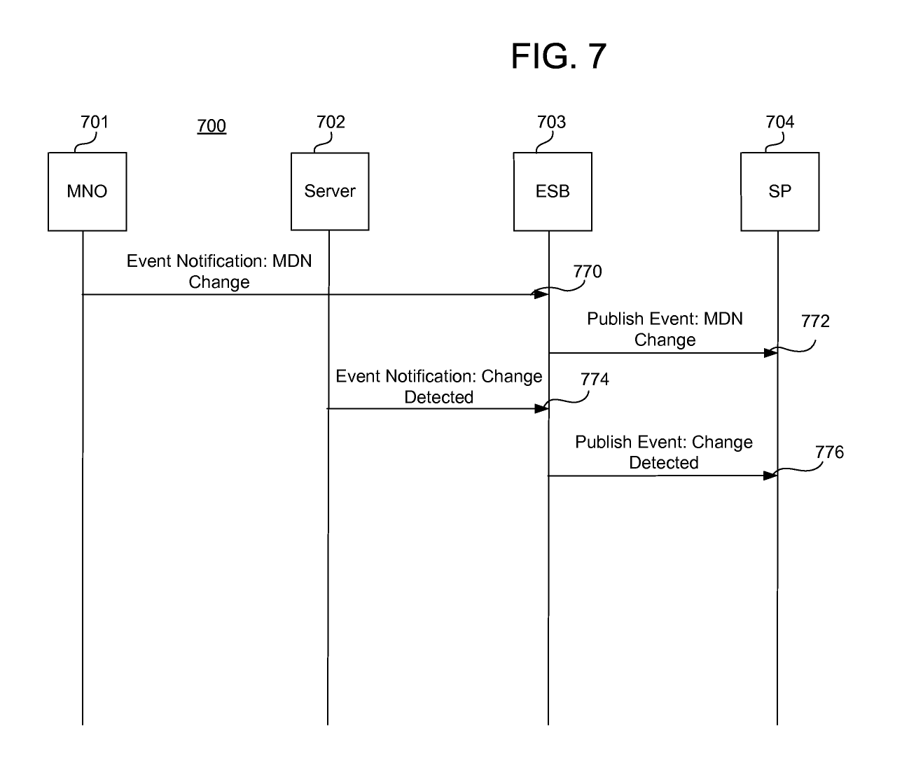

At step 254, the ESB 202 publishes event information (Publish Event: Service Account Created) to the service provider 201. In particular, at step 254, the ESB 202 transmits information to the service provider 201 indicating that a service account record has been created, as requested, on the server 203. Publishing event information is discussed in further detail below with reference to FIG. 7.

The ESB 202 then performs a series of eligibility checks. In particular, the ESB 202 performs a business eligibility check (i.e., MNO eligibility check) and a technical eligibility check (i.e., TSM eligibility check), at steps 256 and 260, respectively.

In particular, at step 256, the ESB 202 transmits a request (Request: MNO Eligibility Check) to the MNO 204 to perform a business eligibility check. The business eligibility check may include validating the MDN identified in the initial request (Request: Set Up Service Account) with the MNO 204. The MNO 204 may then transmit a response to the ESB 202, indicating whether or not the MDN is valid (i.e., whether the business eligibility check passed or failed).

If a determination is made that the MDN is valid (i.e., the business eligibility check passes), the ESB 202 publishes event information (Publish Event: MNO Eligibility Check Passed) to the service provider 201, at step 258. In particular, the ESB 202 transmits information indicating that the MDN was validated with the MNO 204. Publishing event information is described in further detail below with reference to FIG. 7. Alternatively, if a determination is made that the MDN is not valid (i.e., the business eligibility check does not pass), the ESB 202 may transmit a request to the server 203 to remove the service account record created in step 252.

At step 260, the ESB 202 transmits a request (Request: TSM Eligibility Check) to the central TSM 205 to perform a technical eligibility check. This request (Request: TSM Eligibility Check) may include a Wallet Instance ID (e.g., Wallet Instance ID 232) and a GP Service (e.g., GP Service 239), which are used to execute the request. The technical eligibility check may include determining whether an application (e.g., Service Application 234) may be installed on a secure element (e.g., secure element 206). For example, a technical eligibility check may be used to determine whether the secure element 206 has sufficient memory space to have Service Application 234 installed on it. The TSM 205 may then transmit a response to the ESB 202, indicating whether the technical eligibility check passed or failed (i.e., whether or not the application may be installed on the secure element).

If a determination is made that the technical check passed, the ESB 202 publishes event information (Publish Event: TSM Eligibility Check Passed) to the service provider 201, at step 262. In particular, the ESB 202 transmits information indicating that the technical eligibility check passed. Alternatively, if a determination is made that the technical eligibility check does not pass, the ESB 202 may transmit a request to the server 203 to remove the service account record created in step 252.

As further illustrated on FIG. 2, at step 264, the ESB 202 transmits a request to install a service (Request: Install Service) to the central TSM 205. The request (Request: Install Service) may be based on information received by the ESB 202 in the original request (Request: Setup Service Account). In particular, the request (Request: Install Service) may be a request to install one or more applications (e.g., Service Application 234) on a secure element (e.g., FIG. 1, secure element 104a-1).

U.S. patent application Ser. Nos. 13/653,160 and 13/653,145, respectively entitled “Systems, Methods, and Computer Program Products for Interfacing Multiple Service Provider Trusted Service Managers and Secure Elements,” and “Systems, Methods, and Computer Program Products for Managing Secure Elements”, which are incorporated herein by reference in their entirety, describe installing and/or “instantiating” applications on a secure element.

In turn, the TSM 205 may receive the request (Request: Install Service) and install the one or more applications on the secure element. Processing this request may include installing and/or instantiating (i.e., creating and installing an instance of) one or more applications (e.g., payment applications) on a secure element. The TSM 205 may then transmit a response to the ESB 202, indicating the status of the request (Request: Install Service) (i.e., whether or not the desired one or more applications were successfully installed on the secure element).

If a determination is made that the one or more applications were successfully installed on the secure element, as requested, the ESB 202 publishes event information (Publish Event: Successfully Pre-provisioned TSM) to the service provider 201, at step 266. In particular, the ESB 202 transmits information indicating that the request to install a service (Request: Install Service) was successfully processed (i.e., the one or more applications were successfully installed on the secure element). Alternatively, if a determination is made that the request (Request: Install Service) was not successfully processed (i.e., the one or more applications were not successfully installed on the secure element), the ESB 202 may transmit a request to the server 203 to remove the service account record created in step 252.

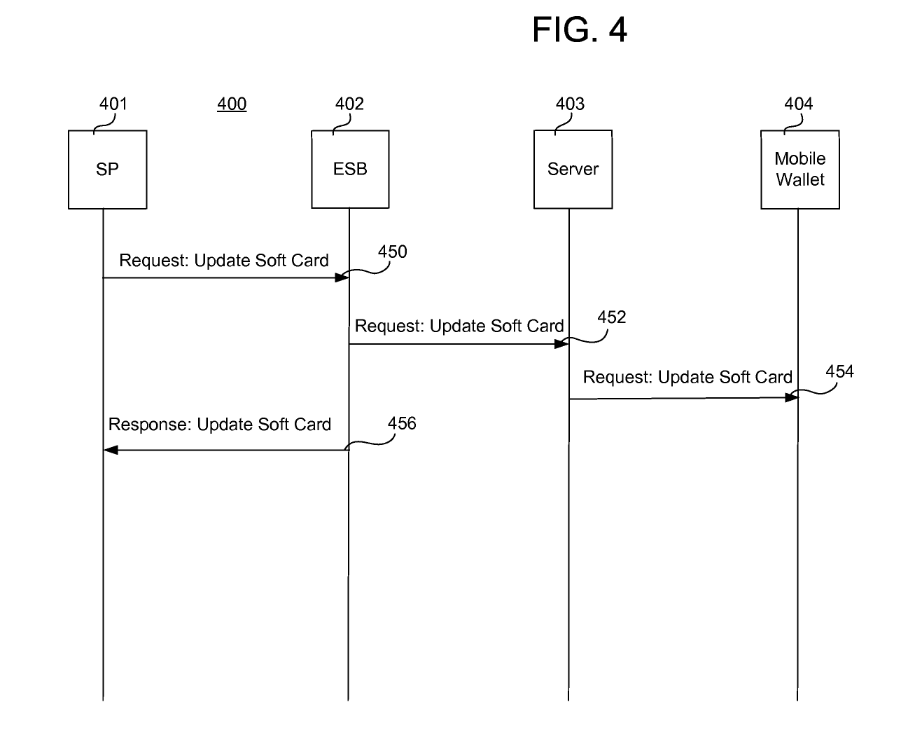

In turn, at step 268, the ESB 202 transmits a request (Request: Add Soft Card) to the server 203 to add a soft card to a mobile wallet 207. In particular, this request (Request: Add Soft Card) may include adding and/or updating soft card information, and/or installing a widget into a mobile wallet. Soft card information in the request may include a Service Account Ref. No. (e.g., Service Account Ref. No. 222) and Service Provider ID (e.g., Service Provider ID 223). Soft cards, including adding a soft card into a mobile wallet, are discussed in more detail below with reference to FIG. 4.

At step 270, the server 203 receives the request (Request: Add Soft Card), and transmits a synchronization request to the mobile wallet 207. A synchronization request may include adding soft card information to a mobile wallet to match soft card information on a server. In particular, at step 270, the server 203 synchronizes with the mobile wallet 207, so that the soft card information in the mobile wallet 207 matches the soft card information (which was received from the ESB 202) in the server 203. The server 203 may then transmit a response to the ESB 202, indicating whether or not the request (Request: Add Soft Card) was successfully processed (i.e., whether or not the soft card information was added to the mobile wallet).

If a determination is made that the request to add a soft card was not successfully processed (i.e., the soft card information was not successfully added to the mobile wallet), the ESB 202 may transmit a request to the central TSM 205 to remove the service installed in step 264. The TSM 205 may then remove (i.e., uninstall) the service from the secure element on which it was installed. The central TSM 207, in turn, may transmit information to the ESB 202, indicating whether or not the service was removed and or uninstalled successfully from the secure element, as requested.

As further shown in FIG. 2, at step 272, the ESB 202 transmits a response (Response: Set Up Service) to the service provider 201, indicating the status of the initial request to set up a service account (Request: Set Up Service Account). In particular, the response (Response: Set Up Service) may include information defining a service account (e.g., Service Account 221) and a response. Table 4 illustrates example parameters defining a response according to sequence 200.

TABLE 4
Examples of Response Parameters

| No. | Parameter | Description | Required |
|---|---|---|---|
| 242 | Response Code | Identifier for determining whether an | Yes |
| | | operation succeeded or failed | |
| 243 | Service Details | Information associated with a service | Yes |
| 244 | Instance ID | Identifier associated with an | Yes |
| | | ESB process | |
| 245 | Transaction ID | Unique identifier associated with | Yes |
| | | a specific transaction | |
| 246 | Timestamp | Time at which a response is | Yes |
| | | transmitted | |
| 247 | Error | Identifier associated with an error | No |
| | | occurring during the execution of an | |
| | | operation | |

Service Details 243 includes information associated with a service, including, for example, a service name, operation name, and version number.

Error 247 includes information used to identify an error and/or exception occurring during the execution of a process. In particular, an error (e.g., Error 247) may include error codes which are associated with corresponding error messages, types (e.g., application exception, business exception, system exception), severity (e.g., a value between 1 and 3), message (i.e., human-readable message), description, and/or trace (e.g., a stack trace used for debugging).

If the initial request (Request: Set Up Service Account) to set up a service account is successfully processed (i.e., a service account is set up as requested), the service provider 201 transmits, at step 274, a request (Request: Install Credentials) to the central TSM 205 to install credentials (e.g., payment credentials) on the secure element 206. The credentials (e.g., account number) are associated with the service account which was set up according to the initial request (Request: Set Up Service Account) from the service provider 201. In turn, the central TSM 205 transmits a request to the secure element 206 to install the credentials. Once the credentials have been installed, as requested, the central TSM 205 transmits a response to the service provider 201 indicating that the credentials were installed on the secure element 206. Processing a request from a service provider to a central TSM to install credentials on a secure element is discussed in detail, for example, in U.S. patent application Ser. No. 13/653,160.

At step 276, the service provider 201 activates the service account, including its associated credentials. Activating a service account may include the service provider 201 transmitting a request to the ESB 202 to set the state of the service account to “WAITING FOR ACTIVATION.” The ESB 202 may then transmit the same request to update the state of the service account to the server 203, and the server 203 may synchronize the mobile wallet 207 to reflect the updated state of the service account (i.e., WAITING FOR ACTIVATION). The server 203 may then transmit to the ESB 202 a response to the request service account, and in turn, the ESB 202 may transmit the same response to the service provider 201. The service account may then be activated, for example, when the user of the mobile wallet 207 contacts the service provider 201. Once the user contacts the service provider 201, the service provider 201 activates the service account, and transmits a request to the ESB 202 to update the state of the service account to “ACTIVE.” The ESB 202 may then transmit the same request to update the state of the service account to the server 203, and the server 203 may synchronize the mobile wallet 207 to reflect the updated state (i.e., ACTIVE).

Once the service account has been activated, the service account will be usable to conduct transactions via the mobile wallet 207.

In an alternative embodiment, the ESB 202 may initiate a process to set up a service account without receiving an initial request (e.g., Request: Set Up Service Account) from the service provider 201. In particular, the ESB 202 may trigger a process to set up a service account at the completion of a wallet activation process.

In an alternative embodiment, if any step in the process of setting up a service account (i.e., steps 250 to 276) fails (i.e., any request is unsuccessfully processed), the ESB 202 may transmit a request to the server 203 to remove the service account record created on the server 203.

### B. Updating the State of a Service Account

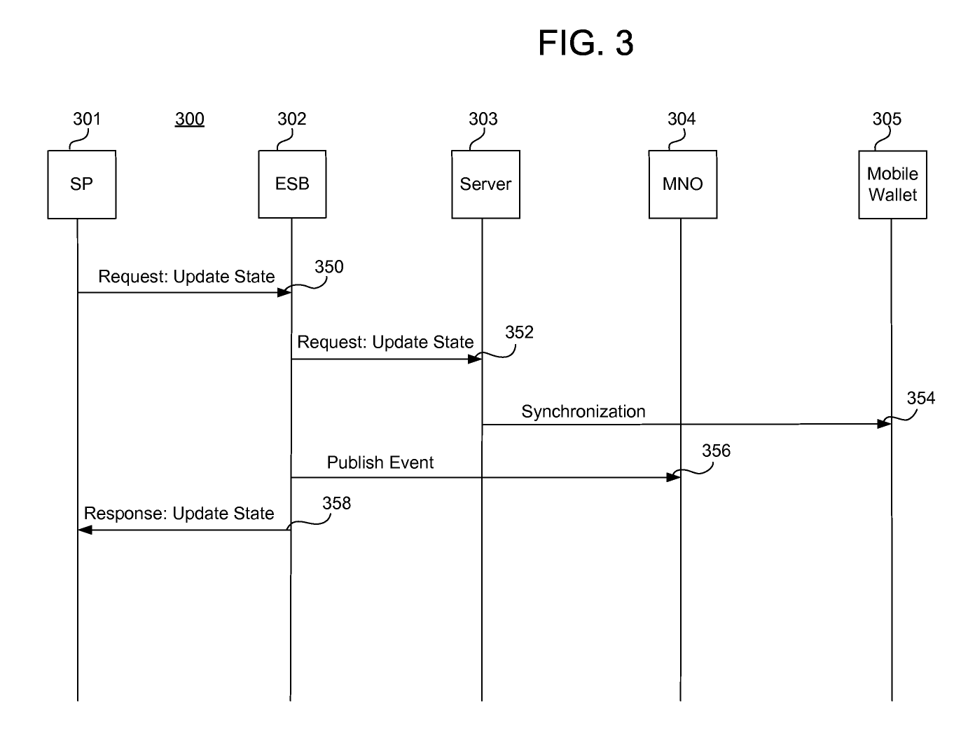

FIG. 3 depicts a sequence diagram 300 for updating the state of a service account on a mobile wallet according to an exemplary embodiment.

As shown in FIG. 3, at step 350, a service provider 301 (e.g., FIG. 1, service provider 105-1) transmits a request (Request: Update State) to an ESB 302 (e.g., FIG. 1, ESB 101) to update the state of a service account. This request follows the “asynchronous message with callback” pattern, discussed above, and may include a message header. Table 5 illustrates example parameters defining a message header in a request (e.g., Request: Update State).

Table 6 illustrates example parameters defining a request to update the state of a service account (e.g., Request: Update State) according to sequence 300.

TABLE 5
Examples of Message Header Parameters

| No. | Parameter | Description | Required |
|---|---|---|---|
| 320 | Reference ID | Unique identifier associated with each | No |
| | | message and/or request generated by a | |
| | | service provider or mobile wallet | |
| 321 | Transaction | Unique identifier associated with each | No |
| | ID | message and/or request generated by an | |
| | | ESB | |
| 322 | Originator | Unique identifier associated with the | No |
| | ID | originator of a message and/or request | |
| | | (e.g., service provider, ESB) | |
| 323 | Date Time | Date and time when the message and/or | No |
| | Stamp | request is originated | |

Table 6 illustrates example parameters defining a request to update the state of a service account (e.g., Request: Update State) according to sequence 300.

TABLE 6
Examples of Update State Request Parameters

| No. | Parameter | Description | Required |
|---|---|---|---|
| 324 | Service | Unique number provided by a service | Yes |
| | Account | provider to uniquely identify a | |
| | Ref No. | service account | |
| 325 | Service | The state to which the service | Yes |
| | Account State | account needs to be updated. | |

Service Account State 325 is a state to which a service account needs to be updated. Table 7 illustrates example states (e.g., Service Account State 325) which a service account may be in or updated to according to sequence 300.

TABLE 7
Examples of Service Account States

| State | Description |
|---|---|
| REGISTERED | Indicates that a request to set up a service account |
| | has been sent to a mobile wallet provider, but the |
| | mobile wallet on which the service account will |
| | be set up has not yet been activated. |
| WAITING FOR | Indicates that a service account has been |
| ACTIVATION | provisioned (i.e., set up) for a mobile wallet on a |
| | mobile device, but the user has not activated the |
| | service account. |
| ACTIVE | Indicates that a service account is active on a |
| | mobile device and can be used by the user. |
| SUSPENDED | Indicates that use of a service account has been |
| | suspended by the service provider, and the |
| | service account may not be used to conduct |
| | payment transactions (but may still be used to |
| | accept payments and/or credits) |
| CLOSED TO NEW | Indicates that a service account has been closed |
| PURCHASES | by the owner of the service account or the service |
| | provider, and the service account may not be |
| | used to conduct payment transactions (but may |
| | still be used to accept payments and/or credits). |
| CLOSED | Indicates that a service account has been closed |
| | by the owner of the service account or the service |
| | provider, and the service account cannot be used |
| | to conduct any transactions and its status cannot |
| | be changed to “ACTIVE.” |

At step 352, the ESB 302 receives the request (Request: Update State) to update the state of a service account, and transmits it to a server 303 (e.g., FIG. 1, server 102). The ESB 302 may modify the request, prior to transmitting it to the server 303, by adding and/or updating information, for example in the message header (e.g., Transaction ID, Originator ID). In turn, the server 303 receives the request (Request: Update State) and synchronizes a mobile wallet 305, at step 354, so that the state of the service account in the mobile wallet 305 matches the state of the service account in server 303.

The ESB 302 may then publish, at step 356, event information (Publish Event) to MNO 304 (e.g., FIG. 1, MNO 106a-1). In particular, at step 356, the ESB 302 transmits information to the MNO 304 indicating that the state of a service account has changed. Publishing event information is discussed in further detail below with reference to FIG. 7.

In turn, the ESB 302 transmits, at step 358, a response (Response: Update State) to the service provider 301, indicating whether or not the request (Request: Update State) was processed successfully. Table 4, above, illustrates example parameters defining a response (e.g., Response: Update State).

In an alternative embodiment, the service provider 301 may transmit a request to get (i.e., retrieve) the state of service account to the ESB 302. In particular, a request to get the state of a service account includes a service account reference number (e.g., Service Account Reference No. 324). The ESB 302 may retrieve the state of the service account for example, from the server 303. In turn, the ESB 302 transmits a response to the service provider 301 including the state of the service account (e.g., Service Account State 325).

### C. Updating Soft Card Information on a Mobile Wallet

FIG. 4 depicts a sequence diagram 400 for updating soft card information on a mobile wallet according to an exemplary embodiment.

As shown in FIG. 4, at step 450, a service provider 401 (e.g., FIG. 1, service provider 105-1) transmits a request (Request: Update Soft Card) to an ESB 402 (e.g., FIG. 1, ESB 101) to update soft card information on a mobile wallet 404. This request follows the “asynchronous message with callback” pattern, discussed above, and may include a message header. Table 5, above, illustrates example parameters defining a message header in a request (e.g., Request: Update Soft Card).

Additionally, a request to update soft card information on a mobile wallet may include soft card information. Table 8 illustrates example parameters defining soft card information in a request (e.g., Request: Update Soft Card) according to sequence 400.

TABLE 8
Examples of Soft Card Information Parameters

| No. | Parameter | Description | Required |
|---|---|---|---|
| 420 | Service Account | Unique number provided by a service | Yes |
| | Ref No. | provider to uniquely identify a service account | |
| 421 | Service Provider ID | Unique identifier used to identify a service | Yes |
| | | provider | |
| 422 | Service Product | Type of service product | No |
| | Type | | |
| 423 | Product Brand | Product brand such as an enumerated value | No |
| | Profile ID | | |
| 424 | Target MDN | Phone number associated with a mobile | No |
| | | device on which a service account will be | |
| | | set up | |
| 425 | Service Account | Indicates the current state of a service | No |
| | State | account | |
| 426 | Operational | Mode in which a service account is | No |
| | Mode | operating | |
| 427 | Account | Nickname of a service account | No |
| | Nickname | | |
| 428 | Attribute Data | A name and value pair that may be used for | No |
| | | miscellaneous purposes | |

At step 452, the ESB 402 receives the request (Request: Update Soft Card) to update soft card information, and transmits it to a server 403 (e.g., FIG. 1, server 102). The ESB 402 may modify the request, prior to transmitting it to the server 403, by adding and/or updating information, for example in the message header (e.g., Transaction ID, Originator ID). In turn, the server 403 receives the request (Request: Update Soft Card) and transmits it to the mobile wallet 404, at step 454.

The ESB 402 then transmits, at step 456, a response (Response: Update Soft Card) to the service provider 401, indicating whether or not the request (Request: Update Soft Card) was processed successfully. Table 4, above, illustrates example parameters defining a response (e.g., Response: Update Soft Card).

### D. Managing Messages to Mobile Wallets

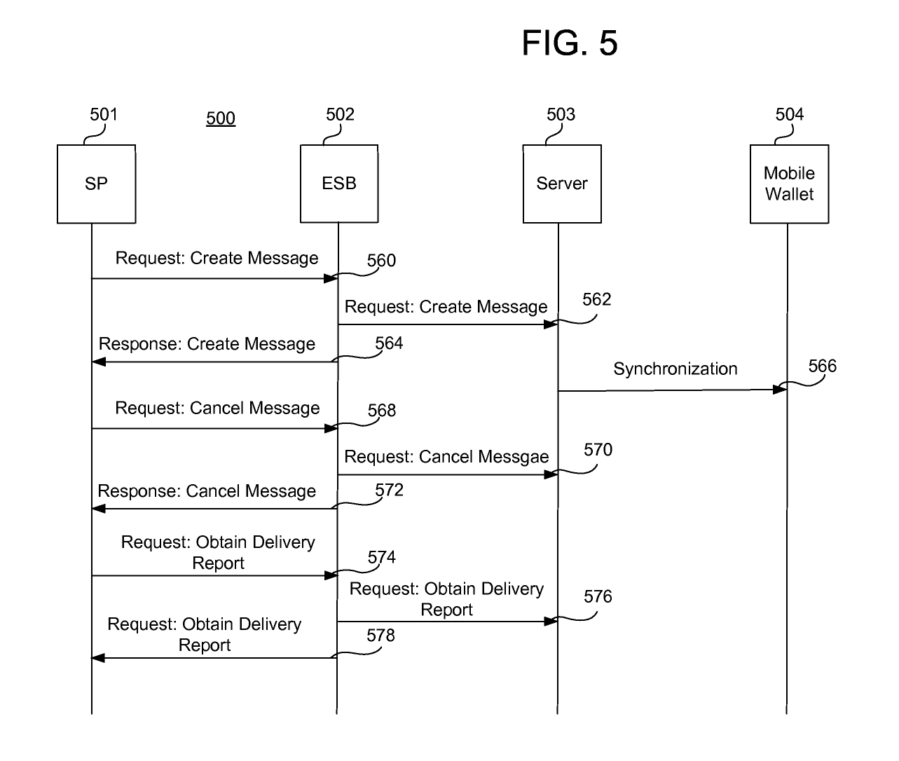

FIG. 5 depicts a sequence diagram 500 for managing messages to a mobile wallet according to an exemplary embodiment.

### 1. Creating Messages

Messages may be transmitted to a specific mobile wallet (Request: Create Message For Wallet) or to “subscriber” mobile wallets (e.g., Request: Create Message). A subscriber mobile wallet is any mobile wallet that is actively subscribed to receive messages from particular sources. That is, if a mobile wallet is subscribed to a source, the mobile wallet will receive messages sent by that source to its subscribers (i.e., via a “Request: Create Message”). A source may be, for example, a service provider. Sources are described in further detail below with reference to Table 11.

As shown in FIG. 5, at step 560, a service provider 501 (e.g., FIG. 1, service provider 105-1) transmits a request (Request: Create Message) to an ESB 502 (e.g., FIG. 1, ESB 101) to create a message. This request follows the “synchronous message” pattern, discussed above, and may include a message header. Table 5, above, illustrates example parameters defining a message header in a request (e.g., Request: Create Message). Additionally, a request to create a message (Request: Create Message) includes message information referred to as an “In Wallet Message.” Table 9 illustrates example parameters defining an “In Wallet Message” included in a request to create a message (Request: Create Message) according to sequence 500.

TABLE 9
Examples of In Wallet Message Parameters

| No. | Parameter | Description | Required |
|---|---|---|---|
| 520 | External | Unique identifier of a message in the | No |
| | Reference ID | message source's domain | |
| 521 | Message Type | Type of message (e.g., notification, | Yes |
| | | offer, activity log) | |
| 522 | Source Name | Unique identifier of a source | Yes |
| | | providing a message | |
| 523 | Message Body | Body of a message | Yes |
| 524 | Expiry Time | Date on which a message is set to | No |
| | Stamp | expire | |
| 525 | Scheduled | Date on which a message is to | No |
| | Delivery Time | become available for delivery | |
| | Stamp | | |
| 526 | Logo Action | Action to be performed when a logo | No |
| | | in a message is clicked and/or | |
| | | selected | |
| 527 | Body Action | Action to be performed when a body | No |
| | | in a message is clicked and/or | |
| | | selected | |
| 528 | Full Logo | Image to be used as logo in a | No |
| | | message | |
| 529 | Full Logo URI | Uniform resource identifier (URI) | No |
| | | (e.g., uniform resource locator | |
| | | (URL)) of a logo hosted on a | |
| | | system | |
| 530 | Partial Logo | Partial mage to be used as logo | No |
| 531 | Partial Logo | URI (e.g., URL) of the partial logo | No |
| | URI | hosted on a system | |
| 532 | Message | A priority code (e.g., integer) | No |
| | Priority Code | indicating the priority of a message. | |

Logo Action 526 and Body Action 527 include information indicating the action to be performed when a logo (e.g., Full Logo 528) or a body (e.g., Message Body 523) are clicked and/or selected, for example, via a user interface of a mobile device. In particular, these actions may include instructions to: “Call Number,” “Load Widget,” “Open Link,” and/or “Show Screen,” in any subscriber mobile wallets such as mobile wallet 504. Instructions to “Call Number” include a phone number to be called; instructions to “Load Widget” include information such as a Widget ID, indicating a widget to be loaded; instructions to “Open Link” include a link (e.g., URL) to be loaded; and instructions to “Show Screen” include information such as a Screen ID, indicating a screen to be loaded.

The ESB 502 creates and assigns a unique Message ID to the message (i.e., “In Wallet Message”) received in the request (Request: Create Message). In turn, the ESB 502 receives the request (Request: Create Message) transmitted at step 560, and transmits it to a server 503 (e.g., FIG. 1, server 102), at step 562. The ESB 502 may modify the request prior to transmitting it to server 503 by adding and/or updating information, for example in the message header (e.g., Transaction ID, Originator ID).

After transmitting the request to the server 503 at step 562, the ESB 502 transmits a response (Response: Create Message) to the service provider 501, at step 564. The response (Response: Create Message) includes response information (discussed in further detail above with reference to Table 4) and the Message ID. The response information may indicate, for example, whether the request to create a message was successfully received and processed by the ESB 502.

In turn, the server 503 receives the request (Request: Create Message) and synchronizes, for example, the mobile wallet 504, at step 566, so that the mobile wallet 504 is updated to include and/or store the message (i.e., “In Wallet Message”). Although not shown, in a similar fashion, the server 503 synchronizes other subscriber mobile wallets so that they are updated to include and/or store the message.

In an alternative embodiment, a request transmitted at step 560 may be a request to create a message for a specific mobile wallet (Request: Create Message For Wallet), as opposed to subscriber mobile wallets. This request may include one or more of the values defined by the parameters discussed with reference to Table 9, as well as a Wallet Instance ID and a Delivery Channel. A Wallet Instance ID is a unique identifier used to identify the mobile wallet for which the message will be created. A Delivery Channel indicates the method by which the message will be delivered and/or transmitted to the mobile wallet (e.g., mobile wallet 504), and may be, for example short message service (SMS) or synchronization, as discussed above.

### 2. Cancelling Messages

As shown in FIG. 5, at step 568, the service provider 501 transmits a request to cancel a message (Request: Cancel Message) to the ESB 502. This request (Request: Cancel Message) may include a Message ID and an External Reference ID, which are discussed above in further detail. The Message ID and External Reference ID are used to identify the message that is to be cancelled.

In turn, the ESB 502 transmits the request (Request: Cancel Message) to the server 503 at step 570, and then transmits a response (Response: Cancel Message) to the service provider 501 at step 572. The response (Response: Cancel Message) includes response information (discussed above in further detail with reference to Table 4) as well as a Response Code indicating whether processing of the requested cancellation was successful or failed.

### 3. Obtaining Message Delivery Reports

As further shown in FIG. 5, at step 574, the service provider 501 transmits a request to obtain a message delivery report (Request: Obtain Delivery Report) to the ESB 502. This request (Request: Obtain Delivery Report) may include a Source Name, External Reference ID, and/or Message ID, which are discussed above in further detail.

The ESB 502 receives the request (Request: Obtain Delivery Report) and transmits it to the server 503 at step 576. In turn, the ESB 502 transmits a response (Response: Obtain Delivery Report) to the service provider 501 at step 578. The response (Response: Obtain Delivery Report) includes response information (discussed above in further detail with reference to Table 4), a Response Code indicating whether processing of the request to obtain a message delivery report was successful or failed, and/or a Message Delivery Record.

Table 10 illustrates example parameters defining a Message Delivery Record according to sequence 500.

TABLE 10
Examples of Message Delivery Record Parameters

| No. | Parameter | Description | Required |
|---|---|---|---|
| 533 | Wallet Instance | Unique identifier for identifying | Yes |
| | ID | a mobile wallet | |
| 534 | Status | Status of the message (e.g., not | Yes |
| | | delivered, sent for delivery, | |
| | | delivered, viewed, operated) | |
| 535 | Delivery Time | Date on which the message was | No |
| | Stamp | downloaded in a mobile wallet | |
| 536 | View Time | Date on which a user viewed a | No |
| | Stamp | message in a mobile wallet | |
| 537 | Operation Time | Date on which a user operated (e.g., | No |
| | Stamp | selected) a message in a mobile | |
| | | wallet | |

### 4. Managing Message Sources

In an alternative embodiment, a service provider (e.g., service provider 501) may transmit a request to an ESB (e.g., ESB 502) to add, update, or cancel a “Message Source.” A Message Source is an entity, such as a service provider, that transmits messages to subscriber mobile wallets. Table 11 illustrates example parameters defining a Message Source.

TABLE 11
Examples of Message Source Parameters

| No. | Parameter | Description | Required |
|---|---|---|---|
| 538 | Source Name | Unique identifying name of a source | Yes |
| 539 | Source Ref. ID | Unique identifier used to identify a source | Yes |
| 540 | Source Type | Type of the source (e.g., mobile wallet | Yes |
| | | issuer, MNO, service provider, merchant) | |
| 541 | Source Nature | Nature of the source (e.g., mandatory, | Yes |
| | | default, optional) | |
| 542 | Welcome | Message to be displayed when an entity | No |
| | Message | (e.g., mobile wallet) subscribes to a source | |
| 543 | Source | Description of a source | No |
| | Description | | |
| 544 | Logo Action | Action to be performed when a logo in a | No |
| | | message of the a source is clicked and/or selected | |
| 545 | Body Action | Action to be performed when a body in a | No |
| | | message of the a source is clicked and/or selected | |
| 546 | Full Logo | Image to be used as logo | No |
| 547 | Full Logo URI | URI (e.g., URL) of the full logo hosted on | No |
| | | a system | |
| 548 | Partial Logo | Partial image used as logo | No |
| 549 | Partial Logo | URI (e.g., URL) of the partial logo hosted | |
| | URI | on a system | |
| 550 | Loyalty Card | URI (e.g., URL) of an image associated | No |
| | Image URI | with a loyalty card | |
| 551 | Loyalty | URI (e.g., URL) of a background image | No |
| | Background | associated with a loyalty card | |
| | Image URI | | |
| 552 | Loyalty Program | Unique identifier associated with a loyalty | No |
| | Identifier | program | |
| 553 | Loyalty Enabled | Indicates if a loyalty program is enabled | No |
| | Indicator | | |
| 554 | Loyalty | Rules defining loyalty account numbers | No |
| | Validation Rule | | |
| 555 | Barcode Type | Unique identifier indicating a type of | No |
| | ID | industry standard barcode to be generated | |

Logo Action 544 and Body Action 545 include information indicating the action to be performed when a logo or a message body corresponding to a source (i.e., Message Source) are clicked and/or selected, for example, via a user interface of a mobile device. As discussed above, these actions may include instructions to: “Call Number,” “Load Widget,” “Open Link,” and/or “Show Screen,” in a mobile wallet.

A request to add a Message Source includes Message Source information, as discussed in Table 11. Upon receiving a request to add a Message Source from a service provider, the ESB may assign a Message Source ID to the received Message Source and stores the Message Source information in association with the Message Source ID. In turn, the ESB transmits to the service provider a response including response information (discussed above in further detail with reference to Table 4), a Response Code, and the corresponding Message Source ID.

Additionally, a request to update a Message Source includes Message Source information (discussed in further detail above with reference to Table 11), and a Message Source ID. Upon receiving a request to update a Message Source from a service provider, the ESB updates stored information corresponding to the received Message Source ID based on the received Message Source information. In turn, the ESB transmits to the service provider a response including response information (discussed above in further detail with reference to Table 4), a Response Code, and the corresponding Message Source ID.

A request to cancel a Message Source includes a Source Name and a Source Reference ID. Upon receiving a request to cancel a Message Source from a service provider, the ESB deletes stored information associated with the received Source Name and Source Reference ID. Deleting information may be done by removing data from its storage location, or by marking the data as “deleted” or “removed,” without actually removing the data from its storage location. In turn, the ESB transmits to the service provider a response including response information (discussed above in further detail with reference to Table 4), and a Response Code.

### 5. Managing Subscriptions to Sources

In an alternative embodiment, a service provider (e.g., service provider 501) may transmit a request to an ESB (e.g., ESB 502) to manage (e.g., update) a subscription to a source. In particular, entities, such as mobile wallets, may be subscribed to receive messages from a source, such as a Message Source (discussed above in further detail).

A request to update a subscription may include a Wallet Instance ID, Source Name, and Status. A Wallet Instance ID is a unique identifier associated with a mobile wallet seeking to update its subscription to a source. A Source Name is a unique name and/or identifier associated with a source. A Status indicates the status with which the subscription to the source corresponding to the Source Name is to be updated, such as, for example, “Activate” or “Discontinue.”

An ESB receives a request to update a subscription from a service provider. In turn, the ESB updates the status of the subscription of the mobile wallet to the source, based on the information received in the request. In turn, the ESB transmits a response to the service provider including response information (discussed above in further detail with reference to Table 4), and a Response Code.

### E. Obtaining a Balance Summary of Service Accounts in Mobile Wallets

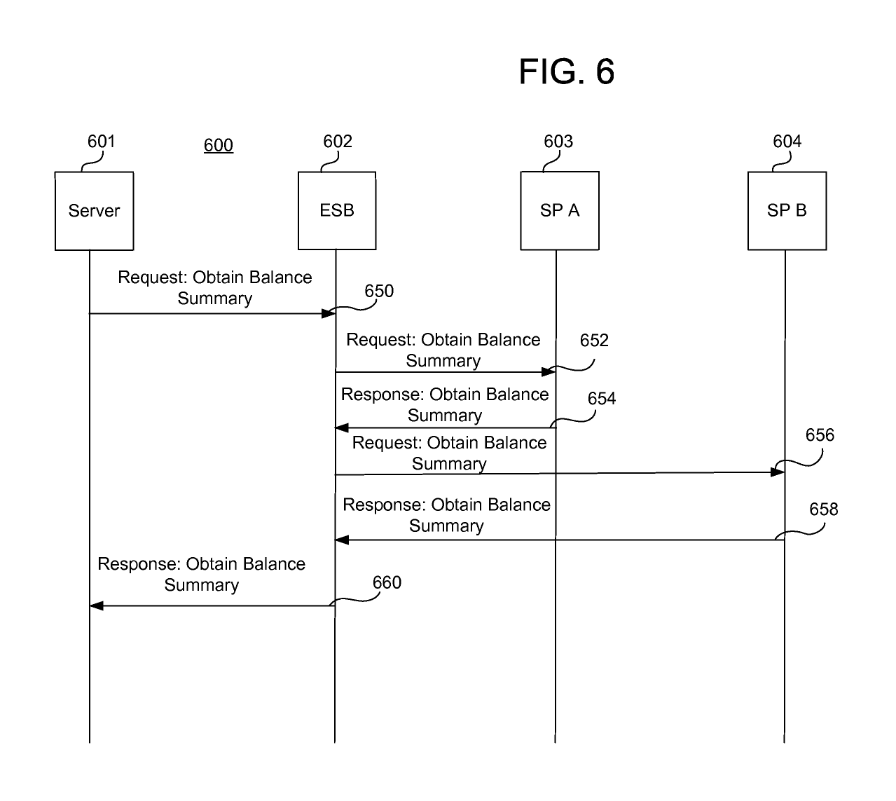

FIG. 6 depicts a sequence diagram 600 for obtaining a balance summary of service accounts in mobile wallets according to an exemplary embodiment.

As shown in FIG. 6, at step 650, a server 601 (e.g., FIG. 1, server 102) transmits a request (Request: Obtain Balance Summary) to an ESB 602 (e.g., FIG. 1, ESB 101) to obtain a balance summary. This request may be transmitted by the server 601 in response to a request from a mobile wallet. For example, a user of the mobile wallet may select or input information prompting the mobile wallet to send a request to the server 601 to obtain a balance summary for one or more service accounts associated with the mobile wallet. Each of the service accounts may be associated with different service providers, such as service provider A 603, and service provider B 604.

A request to obtain a balance summary (Request: Obtain Balance Summary) follows the “asynchronous message with callback” pattern, discussed above, and may include a message header. Table 5, above, illustrates example parameters defining a message header in a request (e.g., Request: Obtain Balance Summary).

In turn, the ESB 602 receives the request (Request: Obtain Balance Summary) transmitted at step 650, and determines the service providers from which it must request a balance (i.e., the service providers associated with the service accounts in the mobile wallet). The ESB 602 then transmits a request to obtain a balance summary (Request: Obtain Balance Summary) at steps 652 and 656, to the service provider A 603 and to the service provider B 604, respectively.

Table 12 illustrates example parameters defining a request to obtain balance summary (Request: Obtain Balance Summary) according to sequence 600.

TABLE 12
Examples of Obtain Balance Summary Request Parameters

| No. | Parameter | Description | Required |
|---|---|---|---|
| 620 | Service | List of service account numbers | Yes |
| | Provider | associated with a specific service | |
| | Details | provider | |
| 621 | Service | Unique identifier for a service provider | Yes |
| | Provider ID | | |
| 622 | Service | Unique number assigned by a service | Yes |
| | Account. | provider to a service account | |
| | Ref. No | | |

The Service Provider Details 620 may be any data structure (e.g., array, list, tree), and includes service account reference numbers associated with a service provider.

In response to the requests transmitted at steps 652 and 656, the service provider A 603 and the service provider B 604 each transmit a response (Response: Obtain Balance Summary) to the ESB 602, at steps 654 and 658, respectively. Each response (Response: Obtain Balance Summary) includes response information (discussed above in further detail with reference to Table 4), and a Balance Summary. A Balance Summary includes balance summary information for a specific service account (i.e., a service account associated with a Service Account Ref. No. transmitted in a request). Table 13 illustrates example parameters defining a Balance Summary.

TABLE 12
Examples of Balance Summary Parameters

| No. | Parameter | Description | Required |
|---|---|---|---|
| 623 | Service | Unique number assigned by a service | Yes |
| | Account | provider to a service account | |
| | Ref. No. | | |
| 624 | Balance Info. | Balance information | Yes |
| 625 | Balance | Information indicating whether or not | No |
| | Retrieval Status | balance information is successfully | |
| | | obtained | |
| 626 | Balance | If balance information is not | |
| | Retrieval | successfully obtained, the reason | |
| | Failure Reason | indicating why the balance | |
| | | information was not obtained | |

Service Account Ref. No. 623 is the unique number associated with the service account for which balance information is to be obtained.

Balance Info 624 includes Account Balance, Available Credit, and/or Payment Due Date. In particular, Account Balance is a balance amount owed by a user of a mobile wallet associated with the service account to the service provider. Available Credit is an amount equaling the difference between an amount of a credit line (i.e., account credit limit) and an amount that has already been borrowed (i.e., account balance). Payment Due Date is a date on which a payment needs to be made to the service account.

In turn, at step 660, the ESB 602 transmits a response (Response: Obtain Balance Summary) to the server 601. This response may include, for example, an aggregate and/or summary of each Balance Summary received by the ESB 602, such as the Balance Summary transmitted at steps 654 and 658.

In an alternative embodiment, the server 601 may transmit to a mobile wallet balance summary information based on the response transmitted at step 660.

### F. Managing Events Related to Mobile Wallets

FIG. 7 depicts a sequence diagram 700 for managing events related to mobile wallets according to an exemplary embodiment.

As shown in FIG. 7, an ESB may receive an “Event Notification” from an MNO (e.g., at step 770), and/or a server (e.g., at step 774). Additionally, an “Event Notification” may be received by an ESB from a service provider, and/or may be generated by the ESB. In general, an Event Notification includes information regarding an event which is to be published by the ESB to subscribers based on the type of event identified in the Event Notification. A subscriber is a system that is predetermined to receive published information regarding predetermined types of events. Subscriber systems correspond (i.e., are controlled and/or managed) to entities such as MNOs, TSMs, mobile wallets, mobile wallets issuers, and/or service providers.

An Event Notification is used to notify subscribers regarding an event. Further, an Event Notification is classified into a Type based on the entity (e.g., MNO, service provider (SP), mobile wallet, ESB) that provides the Event Notification. Optionally, an event notification may include information indicating than an event is pending. Table 13 illustrates example events which are notified to subscribers via Event Notifications.

TABLE 13
Example Events

| Event | Description | Type |
|---|---|---|
| SERVICE ACCOUNT | Information associated with a | ESB Event Notification |
| RECORD CREATED | service account has been | |
| | created on a server | |
| MNO ELIGIBILITY | MNO determines that MDN | ESB Event Notification |
| CHECK PASSED | associated with a service | |
| | account is valid | |
| TSM ELIGIBILITY | MNO determines that a mobile | ESB Event Notification |
| CHECK PASSED | device and secure element are | |
| | eligible to include a service account | |
| SUCCESSFULLY | Predetermined steps have been | ESB Event Notification |
| PRE PROVISIONED | performed ensuring that a TSM | |
| TSM | has been prepared to set up a | |
| | service account | |
| MNO SERVICE | MNO has temporarily | MNO Event Notification |
| SUSPENDED | suspended a consumer's account | |
| MNO SERVICE | MNO has re-activated a | MNO Event Notification |
| REACTIVATED | previously suspended account | |
| MNO SERVICE | MNO has terminated a | MNO Event Notification |
| TERMINATED | consumer's account | |
| MDN CHANGE | MDN associated with a mobile | MNO Event Notification |
| | device has changed | |
| SERVICE ACCOUNT | A service account is active; | SP Event Notification |
| ACTIVATED | mobile wallet can be used for | |
| | transactions | |
| SERVICE ACCOUNT | A service account has been | SP Event Notification |
| CLOSED | closed within SP systems, and | |
| | no transactions can be performed | |
| | with the service account | |
| SERVICE ACCOUNT | A service account has been | SP Event Notification |
| CLOSED TO NEW | suspended and transactions are | |
| PURCHASES | not authorized | |
| SERVICE ACCOUNT | A suspended service account is | SP Event Notification |
| RESUMED | being reactivated | |
| SERVICE ACCOUNT | A service account is not in | SP Event Notification |
| SUSPENDED | good standing; the service | |
| | account is suspended and | |
| | transactions are not authorized | |
| WALLET | Normal operating condition of | Wallet Event Notification |
| ACTIVATED | a mobile wallet; mobile wallet | |
| | can be used for making | |
| | transactions (e.g., make | |
| | payments, redeem offers, | |
| | receive messages) | |
| WALLET | Mobile wallet is suspended and | Wallet Event Notification |
| SUSPENDED | cannot be accessed via a | |
| | corresponding mobile device; | |
| | mobile wallet features are | |
| | disabled | |
| WALLET RESUMED | A suspended mobile wallet is | Wallet Event Notification |
| | reactivated; mobile wallet can | |
| | subsequently be used for | |
| | making transactions (e.g., | |
| | make payments, redeem offers, | |
| | receive messages) | |
| WALLET | Mobile wallet is terminated | Wallet Event Notification |
| TERMINATED | and data is removed from a | |
| | corresponding mobile wallet | |
| | and secure element | |
| LAST ACCOUNT | Last service account on a | Wallet Event Notification |
| REMOVED FROM | mobile wallet is removed | |
| WALLET | | |
| CHANGE | Change associated with a | Wallet Event Notification |
| DETECTED | mobile wallet has been | |
| | detected | |
| CHANGE | Change associated with | Wallet Event Notification |
| RESOLVED | Previously detected change | |
| | associated with a mobile wallet | |
| | has been resolved; mobile | |
| | wallet can be used for making | |
| | transactions | |
| SUBSCRIPTION | Subscription to a mobile wallet | Wallet Event Notification |
| TERMINATED | has been terminated; mobile | |
| | wallet features are disabled | |
| SUBSCRIPTION | Mobile wallet is newly- | Wallet Event Notification |
| STARTED | subscribed and ready for | |
| | activation | |
| WALLET SUSPEND | Mobile wallet may not be | Wallet Event Notification |
| FAILED | reached; attempt to suspend | |
| | wallet has failed | |
| WALLET | Mobile wallet may not be | Wallet Event Notification |
| TERMINATE | reached; attempt to terminate | |
| FAILED | wallet has failed | |

Additionally, an Event Notification includes Event Information and Payload Information. Table 14 illustrates example parameters defining Event Information in an Event Notification.

TABLE 14
Examples of Event Information Parameters

| No. | Parameter | Description | Required |
|---|---|---|---|
| 720 | Event Code | Unique code associated with an event | Yes |
| 721 | Event | Information indicating the entity | Yes |
| | Publisher | providing the event notification (e.g., | |
| | | ESB, MNO, SP, Mobile Wallet) | |
| 722 | Event | A reason, or a code corresponding to a | No |
| | Reason Code | reason, for why an event has occurred | |

Event Code 720 is a unique code or identifier corresponding to an event such as the events listed above in Table 13.

The parameters defining Payload Information in an Event Notification may vary depending on the type of Event Notification. Tables 15-18 illustrate example parameters defining Payload Information based on the type of Event Notification (e.g., ESB, MNO, SP, Wallet), which is discussed in more detail above with reference to Table 13.

TABLE 15
Examples of Payload Information Parameters
in an ESB Event Notification

| No. | Parameter | Description | Required |
|---|---|---|---|
| 723 | MDN | Mobile device number (i.e., phone | No |
| | | number) associated with a handset | |
| 724 | Handset ID | Unique identifier (e.g., IMEI, MEID) | No |
| | | corresponding to a handset | |
| 725 | MNO ID | Unique identifier corresponding to an | No |
| | | MNO (e.g., VERIZON, AT&T, | |
| | | TMOBILE) | |
| 726 | SE ID | Unique identifier (e.g., CIN) | No |
| | | corresponding to a secure element | |
| 727 | Wallet | Unique identifier corresponding to a | No |
| | Instance ID | mobile wallet | |
| 728 | Service | Unique identifier corresponding to a | No |
| | Provider ID | service provider | |
| 729 | Service | Unique identifier assigned by a service | Yes |
| | Account | provider to a service account | |
| | Ref. No. | | |

TABLE 16
Examples of Payload Information Parameters
in an MNO Event Notification

| No. | Parameter | Description | Required |
|---|---|---|---|
| 730 | MDN | Mobile device number (i.e., phone | Yes |
| | | number) associated with a handset | |
| 731 | MNO ID | Unique identifier corresponding to an | Yes |
| | | MNO (e.g., VERIZON, AT&T, | |
| | | TMOBILE) | |
| 732 | Wallet | Unique identifier corresponding to | No |
| | Instance ID | a mobile wallet | |
| 733 | New MDN | A new mobile device number which is | No |
| | | required when an “MDN CHANGE” | |
| | | event occurs | |

TABLE 17
Examples of Payload Information Parameters in a SP Event Notification

| No. | Parameter | Description | Required |
|---|---|---|---|
| 734 | Service | Unique identifier assigned by a service | Yes |
| | Account | provider to a service account | |
| | Ref. No. | | |

TABLE 18
Examples of Payload Information Parameters in a Wallet Event Notification

| No. | Parameter | Description | Required |
|---|---|---|---|
| 735 | MDN | Mobile device number (i.e., phone number) | Yes |
| | | associated with a handset | |
| 736 | Handset ID | Unique identifier (e.g., IMEI, MEID) | Yes |
| | | corresponding to a handset | |
| 737 | MNO ID | Unique identifier corresponding to an MNO | Yes |
| | | (e.g., VERIZON, AT&T, TMOBILE) | |
| 738 | SE ID | Unique identifier (e.g., CIN) corresponding | Yes |
| | | to a secure element | |
| 739 | Wallet Instance ID | Unique identifier corresponding to a mobile wallet | Yes |
| 740 | Service | Service Provider ID. and Service Account | No |
| | Provider Details | Ref. No. associated with an event | |
| 741 | New Handset | A new handset identifier (e.g., IMEI, | No |
| | ID | MEID) which is required when an “MDN | |
| | | CHANGE” event occurs | |
| 742 | New SE ID | A new secure element identifier (e.g., CIN) | No |
| | | which is required when an “MDN | |
| | | CHANGE” event occurs | |
| 743 | Terms and | Version number of terms and conditions | No |
| | Conditions | associated with a mobile wallet | |
| | Version No. | | |

As shown in FIG. 7, at step 770, an MNO 701 (e.g., FIG. 1, MNO 106a-1) transmits an Event Notification (Event Notification: MDN Change) to an ESB 703 (e.g., FIG. 1, ESB 101). As indicated above in Table 13, this Event Notification (Event Notification: MDN Change) is an MNO Event Notification, and therefore includes Event Information, as described in Table 14, and Payload Information, as described in Table 16.

In turn, at step 772, the ESB 703 publishes event information (Publish Event: MDN Change) to the service provider 704. In particular, at step 772, publishing event information includes transmitting the Event Information and Payload Information transmitted to the ESB 703 at step 770.

At step 774, a server 702 (e.g., FIG. 1, server 102) transmits an Event Notification (Event Notification: Change Detected) to the ESB 703. As indicated above, this Event Notification (Event Notification: Change Detected) is a Wallet Event Notification, and therefore includes Event Information, as described in Table 14, and Payload Information, as described in Table 18.

In turn, at step 776, the ESB 703 publishes event information (Publish Event: Change Detected) to the service provider 704. In particular, at step 776, publishing event information includes transmitting the Event Information and Payload Information transmitted to the ESB 703 at step 774.

In an alternative embodiment, the ESB 703 may publish event information (e.g., Publish Event: MDN Change) to the service provider 704 as well as to other subscribers depending on the event identified in the Event Notification, as discussed above.

In an alternative embodiment, the ESB 703 determines that an event has occurred (e.g., MNO Eligibility Check Passed), and publishes event information (as discussed above) to subscribers depending on the event.

In an alternative embodiment, the ESB 703 receives an Event Notification from a service provider (e.g., Event Notification: Service Account Resumed), and publishes event information (as discussed above) to subscribers depending on the event.

In an alternative embodiment, the ESB 703 receives event information (i.e., an Event Notification) indicating that a mobile wallet or secure element cannot be reached or accessed, in order to suspend or terminate the mobile wallet. The ESB 703 may force-suspend or force-terminate the mobile wallet, and in turn, the ESB 703 publishes event information to the service provider 704 indicating that the mobile wallet has been suspended or terminated, respectively (e.g., Event Notification: Wallet Suspend Failed; Event Notification: Wallet Terminate Failed). This is particularly useful for transmitting information to service providers indicating that the mobile wallet cannot be suspended or terminated, and therefore service providers can perform any actions necessary to ensure the security of their corresponding service accounts and related information. That is, even if wallet suspension or termination is unsuccessful, service providers can deactivate service accounts associated with the unreachable mobile wallet.

In an alternative embodiment, the ESB 703 stores at least a portion of received Event Notifications and Event Information, as well as data indicating the event transmitter and the transmission details (e.g., date and time) at any point during an event management process (e.g., the process illustrated in sequence diagram 700).

In an alternative embodiment, the ESB 703 receives an Event Notification (Event Notification: MDN Change) including an indication that the MDN change is a “market change.” A market change results when a mobile handset is transitioned from one billing region to another billing region in the same MNO, resulting in a new MDN but not a new MNO. That is, when a market change occurs, the MDN associated with a handset is changed by the MNO 701. The MNO 701 then informs the ESB 703 by transmitting the Event Notification (Event Notification: MDN Change). Using the information received in the Event Notification, the ESB 703 updates the MDN data associated with a Wallet Instance ID by storing the received data. The ESB 703 then may inform the MNO 701 of the update, but does not need to inform other subscribers (e.g., SP) because other data associated with the mobile wallet has not changed.

### G. Additional Example Implementations

The present invention (e.g., system 100, processes 200-700, or any part(s) or function(s) thereof) can be implemented using hardware, software, or a combination thereof, and can be implemented in one or more mobile device or other processing systems. To the extent that manipulations performed by the present invention were referred to in terms of human operation, no such capability of a human operator is necessary, or desirable in most cases, in any of the operations described herein which form part of the present invention. Rather, the operations described herein are machine operations. Useful machines for performing the operations of the present invention include mobile phones, smartphones, personal digital assistants (PDAs) or similar devices.

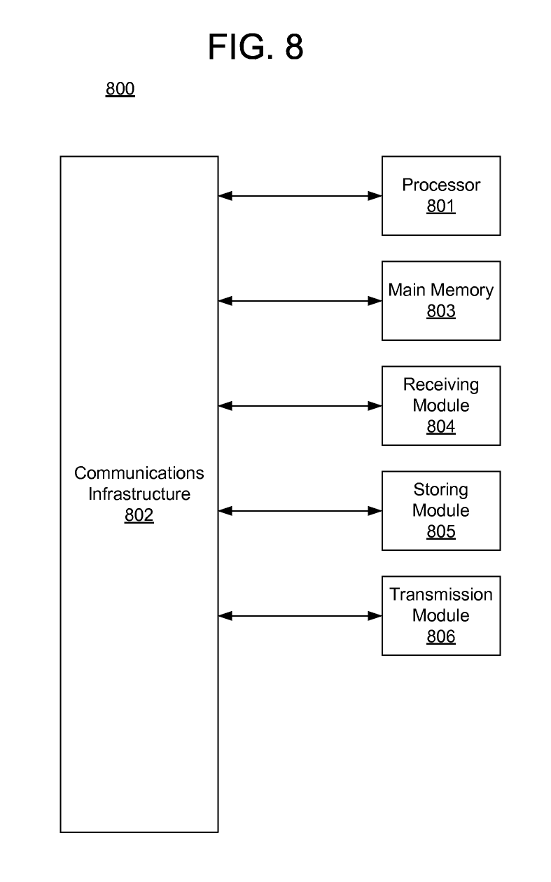

In one embodiment, the invention is directed toward one or more systems capable of carrying out the functionality described herein. An example of a system 800 is shown in FIG. 8.

The system 800 includes one or more processors, such as processor 801. The processor 801 is connected to a communication infrastructure 802 (e.g., communication bus, network). Various embodiments are described in terms of this exemplary system. After reading this description, it will become more apparent to a person skilled in the relevant art(s) how to implement the invention using other systems and/or architectures.

The system 800 also includes a main memory 803, which may be a non-volatile memory, or the like.

The system 800 also includes a receiving module 804 for receiving data such as requests. Receiving requests is discussed in further detail above with reference to FIGS. 2-7.

The system 800 also includes a storing module 805 for storing, for example, data on the main memory 803. Storing data is discussed in further detail above with reference to FIGS. 2-7.

The system 800 also includes a transmission module 806 for transmitting data, such as requests, for example over a communications network. Transmitting data is discussed in further detail above with reference to FIGS. 2-7.

Each of modules 804-806 may be implemented using hardware, software or a combination of the two.

The example embodiments described above such as, for example, the systems and procedures depicted in or discussed in connection with FIGS. 1-7, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a non-transitory storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the non-transitory computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing communications, the system comprising:
at least one memory; and
a processor coupled to the at least one memory, the processor being operable to:
receive a first request from a requestor system;
store the first request in the at least one memory;
transmit, to a mobile wallet server, a second request based on the first request; and
transmit a response to the requestor system, the response including a response code indicating a status of processing of the first request,
wherein the first request is one of a request to (1) set up a service account, (2) update a service account state, (3) update information in a mobile wallet, (4) manage messages, (5) obtain account information, or (6) publish event information.

2. The system of claim 1, wherein the first request is a request to set up a service account, and includes service account information.

3. The system of claim 2, wherein the service account information includes a service account reference number, a service provider identifier (ID), and a target mobile device number (MDN).

4. The system of claim 2, wherein the processor is further operable to:
transmit a business eligibility check request to a mobile network operator (MNO); and
transmit a technical eligibility check request to a central trusted service manager (TSM).

5. The system of claim 1, wherein the first request includes a message header comprising at least one of (1) a reference ID, (2) a transaction ID, and (3) an originator ID.

6. The system of claim 1, wherein the first request is a request to update a service account state, and includes a service account reference number and a service account state.

7. The system of claim 1, wherein the first request is a request to update information in a mobile wallet, and includes soft card information comprising a service account reference number, and a service provider ID.

8. The system of claim 1, wherein the first request is a request to manage messages, and includes a message comprising a message type, a source name, and a message body.

9. A method for managing communications, the method comprising steps of:
receiving a first request from a requestor system;
storing the first request in at least one memory;
transmitting, to a mobile wallet server, a second request based on the first request; and
transmitting a response to the requestor system, the response including a response code indicating a status of processing of the first request,
wherein the first request is one of a request to (1) set up a service account, (2) update a service account state, (3) update information in a mobile wallet, (4) manage messages, (5) obtain account information, or (6) publish event information.

10. The method of claim 9, wherein the first request is a request to set up a service account, and includes service account information.

11. The method of claim 10, wherein the service account information includes a service account reference number, a service provider identifier (ID), and a target mobile device number (MDN).

12. The method of claim 10, further comprising steps of:
transmitting a business eligibility check request to a mobile network operator (MNO); and
transmitting a technical eligibility check request to a central trusted service manager (TSM).

13. The method of claim 9, wherein the first request includes a message header comprising at least one of (1) a reference ID, (2) a transaction ID, and (3) an originator ID.

14. The method of claim 9, wherein the first request is a request to update a service account state, and includes a service account reference number and a service account state.

15. The method of claim 9, wherein the first request is a request to update information in a mobile wallet, and includes soft card information comprising a service account reference number, and a service provider ID.

16. The method of claim 9, wherein the first request is a request to manage messages, and includes a message comprising a message type, a source name, and a message body.

17. A non-transitory computer-readable medium having stored thereon sequences of instructions for causing one or more processors to:
receive a first request from a requestor system;
store the first request in at least one memory;
transmit, to a mobile wallet server, a second request based on the first request; and
transmit a response to the requestor system, the response including a response code indicating a status of processing of the first request,
wherein the first request is one of a request to (1) set up a service account, (2) update a service account state, (3) update information in a mobile wallet, (4) manage messages, (5) obtain account information, or (6) publish event information.

18. The computer-readable medium of claim 17, wherein the first request is a request to set up a service account, and includes service account information.

19. The computer-readable medium of claim 18, wherein the service account information includes a service account reference number, a service provider identifier (ID), and a target mobile device number (MDN).

20. The computer-readable medium of claim 18, wherein the sequence of instructions further cause the one or more processors to:
transmit a business eligibility check request to a mobile network operator (MNO); and
transmit a technical eligibility check request to a central trusted service manager (TSM).

21. The computer-readable medium of claim 17, wherein the first request includes a message header comprising at least one of (1) a reference ID, (2) a transaction ID, and (3) an originator ID.

22. The computer-readable medium of claim 17, wherein the first request is a request to update a service account state, and includes a service account reference number and a service account state.

23. The computer-readable medium of claim 17, wherein the first request is a request to update information in a mobile wallet, and includes soft card information comprising a service account reference number, and a service provider ID.

24. The computer-readable medium of claim 17, wherein the first request is a request to manage messages, and includes a message comprising a message type, a source name, and a message body.

25. A system for managing communications, the system comprising:
at least one memory; and
a processor coupled to the at least one memory, the processor being operable to:
receive a notification from a publisher system;
store the notification in the at least one memory;
determine, based on the notification, one or more subscriber systems; and
transmit the notification to the one or more subscriber systems;
wherein the notification includes event information and payload information.

26. A method for managing communications, the method comprising steps of:
receiving a notification from a publisher system;
storing the notification in at least one memory;
determining, based on the notification, one or more subscriber systems; and
transmitting the notification to the one or more subscriber systems;
wherein the notification includes event information and payload information.

27. A non-transitory computer-readable medium having stored thereon sequences of instructions for causing one or more processors to:
receive a notification from a publisher system;
store the notification in at least one memory;
determine, based on the notification, one or more subscriber systems; and
transmit the notification to the one or more subscriber systems;
wherein the notification includes event information and payload information.
